(19) United States
(12) Patent Application Publication
(10) Pub. No.: US 2006/0004972 A1
(43) Pub. Date: Jan. 5, 2006

(54) Semiconductor memory device and method of testing the same

(76) Inventor: Chan-Kyung Kim, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/126,573

(22) Filed: May 10, 2005

(30) Foreign Application Priority Data
Jul. 5, 2004 (KR) 2004-52055

(51) Int. Cl. G06F 12/00

(52) U.S. Cl. 711/154

(57) ABSTRACT

The invention discloses a semiconductor memory device and a method of testing the same. The semiconductor memory device comprises a memory for receiving or outputting data in response to a first clock signal; an input converting means for converting and outputting input data in response to a second clock signal; and an output converting means for converting and outputting data outputted from the memory in a first test mode and converting and outputting data outputted from the input converting means in a second test mode, in response to the second clock signal. Therefore, in case that the semiconductor memory device has a plurality of frequency regions, it is possible to recognize which frequency regions among a plurality of frequency regions may be suboptimal.

### CROSS-REFERENCE TO RELATED APPLICATION

This application claims priority and benefit of Korean Patent Application No. 2004-52055, filed Jul. 5, 2004, the disclosure of which is hereby incorporated by reference in its entirety.

### BACKGROUND OF THE INVENTION

1. Field of the Invention

The invention relates to a semiconductor memory device and, more particularly, to a semiconductor memory device which uses a plurality of different frequencies and a method of testing the same.

2. Description of the Related Art

Semiconductor memory devices usually have a plurality of pipe lines to input or output data at a higher speed than the operation speed of a memory while maintaining the operation speed of the memory. That is, data can be input or output at a higher frequency than a frequency that a memory operates such that, during input operation, the number of bits is increased and the operation frequency is lowered by de-serializing data to be input and, during output operation, the number of bits is reduced and the operation frequency is raised by serializing data to be output.

FIG. 1 is a block diagram illustrating a semiconductor memory device and a test device to test the same according to a conventional art. The semiconductor memory device 1 includes a clock generating portion 10, a memory 20, a read pipe 32, a write pipe 34, a read circuit 42, and a write circuit 44. The test device 50 includes a data receiving portion 52 and a data transmitting portion 54.

As shown in FIG. 1, the conventional semiconductor memory device 1 performs data input/output operations such that data outputted from the data transmitting portion 54 of the test device 50 are inputted to the memory 20 through the data write circuit 44 and the write pipe 34, and data outputted from the memory 20 are inputted to the data receiving portion 52 of the test device 50 through the read pipe 32 and the read circuit 42. Here, the memory 20, the read pipe 32 and the write pipe 34, the read circuit 42 and the write circuit 44 operate in response to clock signals clk1, clk2 and clk3 which have different frequencies from each other.

The clock generating portion 10 receives a clock signal clk outputted from the test device 50 to output clock signals clk1, clk2, and clk3 having different frequencies.

The memory 20 outputs a first read data DR1, in response to a first clock signal clk1, and receives and stores a first write data DW1. That is, the memory 20 outputs a first predetermined-bit, for example, 16-bit first read data DR1, using a first clock signal clk1 and receives and stores the first predetermined-bit, for example, 16-bit first write data DW1.

The read pipe 32 and the write pipe 34 serialize and de-serialize data to be input, respectively, in response to a second clock signal clk2 having a higher frequency than a first clock signal clk1. That is, the read pipe 32 serializes a first read data DR1 to output a second predetermined-bit which is smaller than the first predetermined-bit, for example, 4-bit second read data DR2 using a second clock signal clk2. The write pipe 34 de-serializes a second predetermined-bit, for example, 4-bit second write data DW2 outputted from the write circuit 44 using a second clock signal clk2 to output the first predetermined-bit, for example, 16-bit first write data DW1.

The read circuit 42 and the write circuit 44 serialize and de-serialize data to be input, respectively, in response to a third clock signal clk3 having a higher frequency than a second clock signal clk2. That is, the read circuit 42 serializes a second read data DR2 to output a third predetermined-bit which is smaller than the second predetermined-bit, for example, 1-bit third read data DR3 using a third clock signal clk3. The write circuit 44 de-serializes a third predetermined-bit, for example, 1-bit third write data DW3 outputted from the data transmitting portion 54 of the test device 50 using a third clock signal clk3 to output the second predetermined-bit, for example, 4-bit second write data DW2.

The test device 50 outputs the clock signal clk to the clock generating portion 10 of the semiconductor memory device 1. Also, the test device 50 performs a test operation while receiving the third read data DR3 through the data receiving portion 52 and transmitting the third write data DW3 through the data transmitting portion 54.

If 16-bit data are serialized to 4-bit and then transmitted or 4-bit data are serialized to 1-bit and transmitted, succeeding read data transmission rates should increase by four times. On the contrary, if 1-bit data are de-serialized to 4-bit and then transmitted or 4-bit data are de-serialized to 16-bit and transmitted, succeeding write data transmission rates should decrease by a fourth (¼). Therefore, if it is assumed that a transmission rate of the first read data DR1 and the first write data DW1 which the memory 20 receives or outputs is 200 Mbps, a transmission rate of the second read data DR2 and the second write data DW2 becomes 800 Mbps, and a transmission rate of the third read data DR3 and the third write data DW3 becomes 3.2 Gbps.

In this case, to receive and output the first read data DR1 and the first write data DW1 of 200 Mbps, a clock signal of 200 MHz is required. Therefore, a frequency of a first clock signal clk1 becomes 200 MHz. Also, to serialize the 16-bit first read data DR1 of 200 Mbps to the 4-bit second read data DR2 of 800 Mbps or to de-serialize the 4-bit second write data DW2 of 800 Mbps to the 16-bit first write data DR1 of 200 Mbps, a clock signal of 800 MHz is required. Therefore, a frequency of a second clock signal clk2 becomes 800 MHz. Also, to serialize the 4-bit second read data DR2 of 800 Mbps to the 1-bit third read data DR3 of 3.2 Gbps or to de-serialize the 1-bit third write data DW3 of 3.2 Gbps to the 4-bit second write data DR2 of 800 Mbps, a plurality of clock signals which are different in phase of 800 Mbps are required. Therefore, a frequency of a third clock signal clk3 becomes 3.2 GHz.

For example, in case of extreme data rate (“XDR”) DRAM, fast operation speed is achieved by generating a second clock signal clk2 of 400 MHz, and a third clock signal clk3 of a multi phase having 800 MHz and a phase difference of 90° by using a first clock signal clk1 of 200 MHz.

Namely, the semiconductor memory device 1 includes the memory 20 which operates in response to a first clock signal clk1 having a first frequency area, i.e., a first frequency, the read pipe 32 and the write pipe 34 which operate in response to a second clock signal clk2 having a second frequency area, i.e., a second frequency, the read circuit 42 and the write circuit 44 which operate in response to a third clock signal clk3 having a third frequency area, i.e., a third frequency, and the semiconductor memory device 1 receives/outputs data a higher speed than operation speed of the memory 20.

However, the conventional semiconductor memory device performs the test at the same time without classifying the first frequency area, the second frequency area, and the third frequency area. Thus, if one of the frequency areas is suboptimal, since data outputted from the frequency area which is suboptimal are serialized or de-serialized while passing through different frequency areas, there is no method for recognizing which frequency area may be suboptimal.

### SUMMARY OF THE INVENTION

The invention provides a semiconductor memory device, comprising: a memory for receiving or outputting data in response to a first clock signal; an input converting means for converting and outputting input data in response to a second clock signal; and an output converting means for converting and outputting data outputted from the memory in a first test mode and converting and outputting data outputted from the input converting means in a second test mode, in response to the second clock signal.

The invention further provides a semiconductor memory device, comprising: a memory for receiving or outputting data in response to a first clock signal; an input converting means for converting and outputting input data in response to a second clock signal; and a first output converting means for converting and outputting data outputted from the memory in a first test mode and converting and outputting data outputted from the input converting means in a second test mode, in response to the second clock signal; a second input converting means for converting and outputting input data in response to a third clock signal; and a second output converting means for converting and outputting data outputted from the first output converting means in the first test mode or the second test mode and converting and outputting data outputted from the second input converting means in a third test mode, in response to the third clock signal.

The invention further provides a method of testing a semiconductor memory device including a memory for receiving or outputting data in response to a first clock signal, and an input/output means for converting and outputting data in response to a second clock signal, the method comprising: testing the input/output means; and testing the memory.

The invention further provides a method of testing a semiconductor memory device including a memory for receiving or outputting data in response to a first clock signal, a first input/output means for converting and outputting data in response to a second clock signal, and a second input/output means for converting and outputting data in response to a third clock signal, the method comprising: testing the second input/output means; testing the first input/output means; and testing the memory.

### BRIEF DESCRIPTION OF THE DRAWINGS

The above and other features and advantages of the invention will become more apparent to those of ordinary skill in the art by describing in detail preferred embodiments thereof with reference to the attached drawings in which:

FIG. 1 is a block diagram illustrating a semiconductor memory device and a test device according to a conventional art;

FIG. 2 is a block diagram illustrating a semiconductor memory device and a test device according to a first embodiment of the invention;

FIG. 3 is a block diagram illustrating a semiconductor memory device and a test device according to a second embodiment of the invention; and

FIG. 4 is a flow chart illustrating a method of testing the semiconductor memory device of the invention.

### DETAILED DESCRIPTION OF THE EMBODIMENTS

The invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

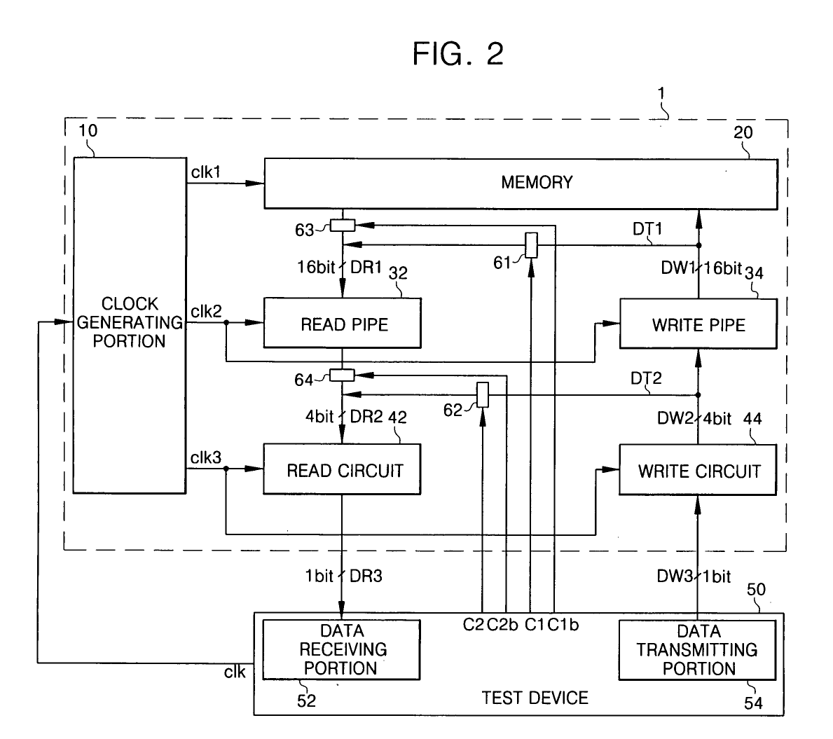

FIG. 2 is a block diagram illustrating a semiconductor memory device and a test device according to a first embodiment of the invention. The semiconductor memory device 1 includes a clock generating portion 10, a memory 20, a read pipe 32, a write pipe 34, a read circuit 42, and a write circuit 44, a first independent data path DT1 which connects the read pipe 32 and the write pipe 34, a second independent data path DT2 which connects the read circuit 42 and the write circuit 44, and four switching means 61, 62, 63, and 64. The test device 50 includes a data receiving portion 52 and a data transmitting portion 54.

Functions of the components of FIG. 2 are explained below.

The clock generating portion 10 receives a clock signal clk outputted from the test device 50 to output clock signals clk1, clk2, and clk3 having different frequencies.

The memory 20 receives and outputs data in response to a first clock signal clk1. That is, the memory 20 receives and stores a first write data DW1 in response to a first clock signal clk1, and outputs a first read data DR1 in response to a first clock signal clk1.

The write pipe 34 receives, de-serializes and outputs data outputted from the write circuit 44 in response to a second clock signal clk2.

The read pipe 32 receives, serializes, and outputs data outputted from the memory 20 or the write pipe 34 in response to a second clock signal clk2.

The write circuit 44 receives, de-serializes and outputs data outputted from an external portion, i.e., the data transmitting portion 54 of the test device 50, in response to a third clock signal clk3.

The read circuit 42 receives, serializes and outputs data outputted from the read pipe 32 or the write circuit 44 in response to a third clock signal clk3.

The test device 50 outputs data through the data transmitting portion 54 while outputting the clock signal clk to the clock generating portion 10 of the semiconductor memory device 1, and performs a test operation while receiving data through the data receiving portion 52. The test device 50 also outputs control signals C1, C2, C1b, and C2b according to a frequency region of the semiconductor memory device 1 to be tested.

The four switching means 61, 62, 63, and 64 may be comprised of a plurality of transmission gates and are turned on or off in response to control signals C1, C2, C1b, and C2b, respectively.

Operation of the semiconductor memory device of FIG. 2 is explained below.

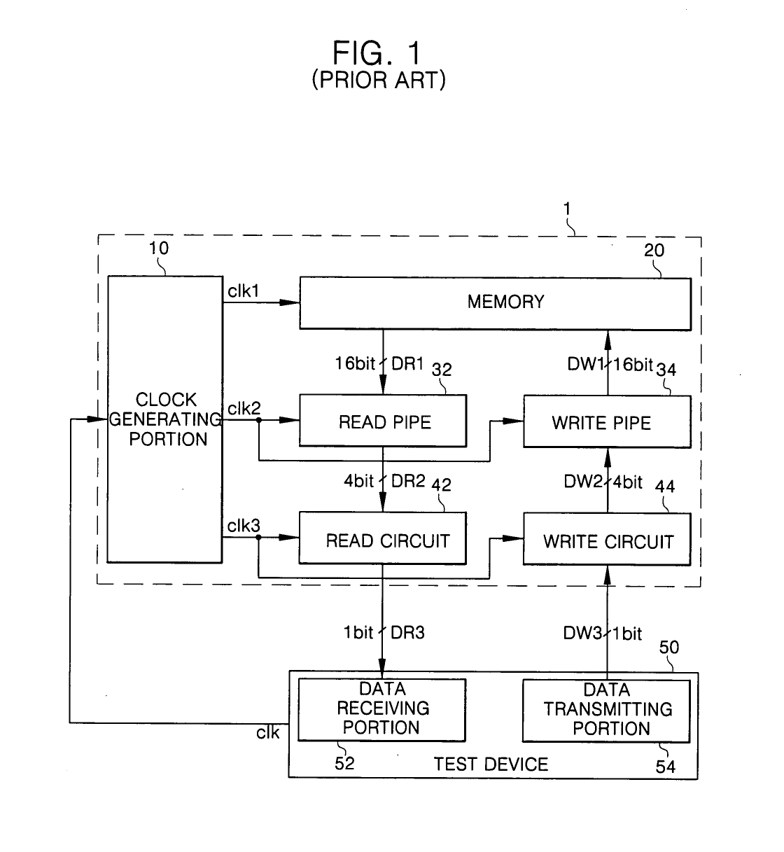

The semiconductor memory device of FIG. 2, compared to the conventional semiconductor memory device of FIG. 1, further includes the first independent data path DT1 which directly connects the read pipe 32 to the write pipe 34 and the second independent data path DT2 which directly connects the read circuit 42 to the write circuit 44. Therefore, it is possible to independently recognize which of the different frequencies may be suboptimal during a test operation.

Using the second independent data path DT2 provided, a second write data DW2 outputted from the write circuit 44 can be directly inputted to the read circuit 42 during a test operation. By activating a second control signal C2 to turn on the second switching means 62 and inactivating an inverted second control signal C2b to turn off the fourth switching means 64, data outputted from the write circuit 44 are directly inputted to the read circuit 42. At the same time, operation of the read pipe 32, the write pipe 34 and the memory 20 does not affect data to be inputted to the data receiving portion 52 of the test device 50. Thus, it is possible to independently test the read circuit 42 and the write circuit 44 which converts data inputted in response to a third clock signal clk3 having a third frequency region, i.e., a third frequency (800 MHz). Therefore, it is possible to check whether or not a third frequency region is suboptimal.

Using the first independent data path DT1 provided, a first write data DW1 outputted from the write pipe 34 can be directly inputted to the read pipe 32 during a test operation. By inactivating a second control signal C2 to turn off the second switching means 62, activating an inverted second control signal C2b to turn on the fourth switching means 64, activating a first control signal C1 to turn on the first switching means 61, and inactivating an inverted first control signal C1b to turn off the third switching means 63, data outputted from the data transmitting portion 54 are inputted to the data receiving portion 52 through the write circuit 44, the write pipe 34, the read pipe 32, and the read circuit 42 without passing through the memory 20. Thus, it is possible to independently test the read pipe 32 and the write pipe 34 which converts data inputted in response to a second clock signal clk2 having the third frequency region and a second frequency region, i.e., a second frequency (400 MHz). After the third frequency region passes a test, testing the third frequency region and the second frequency region can obtain the same effect as testing only the second frequency region. Therefore, it is possible to check whether or not the second frequency region is suboptimal.

Also, after the third frequency region and the second frequency region pass a test, the memory 20 is tested that receives or outputs in response to a first clock signal clk1 having the third frequency region, the second frequency region, and the first frequency region, i.e., the first frequency (e.g., 200 MHz). By inactivating a first control signal C1 and a second control signal C2 to turn off the first and second switching means 61 and 62 and activating an inverted first control signal C1b and an inverted second control signal C2b to turn on the third and fourth switching means 63 and 64, data outputted from the data transmitting portion 54 are inputted to the data receiving portion 52 through the write circuit 44, the write pipe 34, the memory 20, the write pipe 32, and the read circuit 42. Thus, testing the first, second, and third frequency regions can obtain the same effect as testing only the first frequency region. Therefore, it is possible to check whether or not the first frequency region is suboptimal.

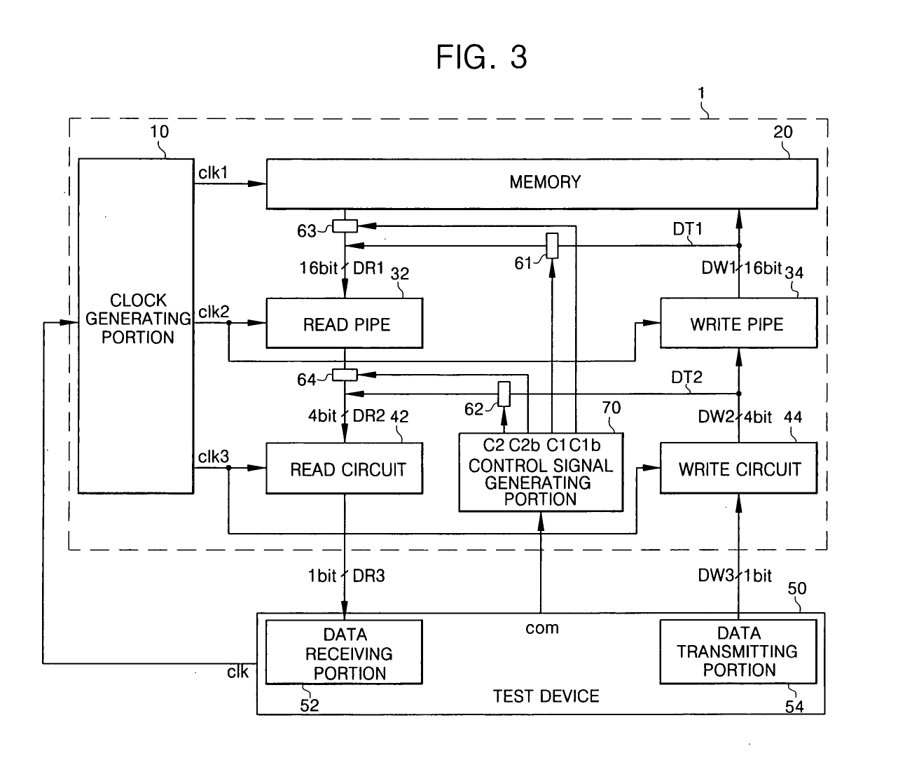

FIG. 3 is a block diagram illustrating a semiconductor memory device and a test device according to a second embodiment of the invention. The semiconductor memory device 1 of FIG. 3 includes a clock generating portion 10, a memory 20, a read pipe 32, a write pipe 34, a read circuit 42, and a write circuit 44, a first independent data path DT1 which connects the read pipe 32 and the write pipe 34, a second independent data path DT2 which connects the read circuit 42 and the write circuit 44, four switching means 61, 62, 63, and 64, and a control signal generating portion 70. The test device 50 includes a data receiving portion 52 and a data transmitting portion 54.

Functions of the components of FIG. 3 are explained below.

Like reference numerals of FIGS. 2 and 3 denote like parts and perform like operations. In FIG. 3, the test device 50 outputs a command corn according to a frequency region of the semiconductor memory device 1 to be tested.

The control signal generating portion 70 outputs control signals C1, C2, C1b, and C2b for controlling the switching means 61, 62, 63, and 64, respectively, in response to a command corn outputted from the test device 50.

Operation of the components of FIG. 3 is explained below.

The test device 50 outputs a command corn according to a frequency region of the semiconductor memory device 1 to be tested. The control signal generating portion 70 outputs the control signals C1, C2, C1b and C2b in response to the command com. Therefore, as described in FIG. 2, it is possible to check whether or not the respective frequency regions may be suboptimal.

The control signal generating portion 70 may be comprised of a separate logic circuit or a mode setting register. Even though not shown, if the control signal generating portion 70 is comprised of the mode setting register, the test device 50 may be configured to output information about a frequency region of the semiconductor memory device 1 to be tested through an address signal line as well as the command corn, and the mode setting register may be configured to output the command corn and the control signals C1, C2, C1b, and C2b in response to information about the frequency region.

In another embodiment, the switching means 61, 62, 63, and 64 of the semiconductor memory device of FIGS. 2 and 3 may be comprised of a multiplexer MUX instead of a transmission gate. That is, the multiplexer is configured to selectively output data of a predetermined level (e.g., power voltage or ground voltage) or input data signal in response to the control signals C1, C2, C1b, and C2b, and thus play the same role as the switching means 61, 62, 63, and 64 are comprised of a transmission gate. In other words, the multiplexer is configured to select a voltage of a predetermined voltage in order to cut off signal lines such as the first and second data paths DT1 and DT2 and to select input data signal in order to transmit data through the signal lines.

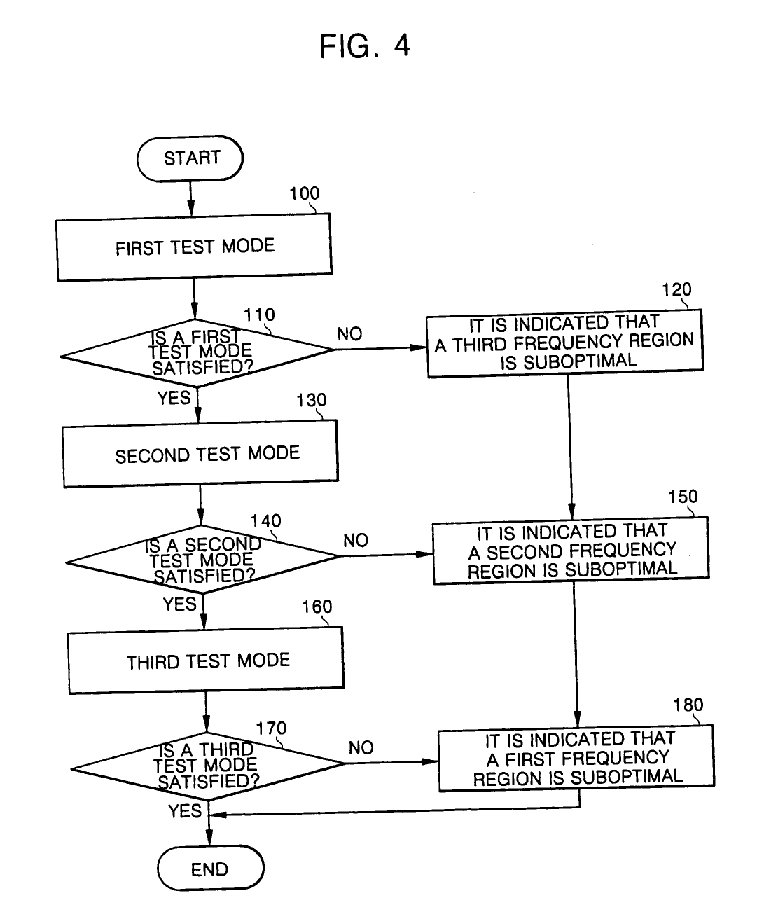

FIG. 4 is a flow chart illustrating a method of testing the semiconductor memory device of the invention.

A first test mode for testing a third frequency region is executed (step 100). That is, a test operation is initialized by directly inputting data outputted from the write circuit 44 to the read circuit 42.

Next, it is determined whether or not the first test mode is satisfied; that is, whether or not the semiconductor memory device is suboptimal (step 110) at the third frequency region.

If the first test mode is not satisfied, it is indicated that the third frequency region is suboptimal and the test is finished (step 120).

However, if the first test mode is satisfied, a second test mode for testing a second frequency region is executed (step 130). That is, a test operation is performed such that data outputted from the write circuit 44 are inputted to the read circuit 42 through the write pipe 34 and the read pipe 32. Since the third frequency region, i.e., the read circuit 42 and the write circuit 44, has been already tested at the step 100, the same effect as only the second frequency region, i.e., the read pipe 32 and the write pipe 34, is tested can be obtained.

Thereafter, it is determined whether or not the second test mode is satisfied; that is, whether or not the semiconductor memory device is suboptimal (step 140) at the second frequency region.

If the second test mode is not satisfied, it is indicated that the second frequency region is suboptimal, and the test is finished (step 150). That is, since the third frequency region has satisfied the test at the steps 100 and 110, if the test is not satisfied at step 140, it can be seen that the second frequency region is suboptimal.

If the second test mode is satisfied, a third test mode for testing a first frequency region is executed (step 160). That is, data outputted from the write circuit 44 are inputted to the read circuit 44 through the write pipe 34, the memory 20, and the read pipe 32. Since the third frequency region, i.e., the read circuit 42 and the write circuit 44, and the second frequency region, i.e., the read pipe 32 and the write pipe 44, have been already tested at the steps 100 and 130, the same effect as only the first frequency region, i.e., the memory, is tested can be obtained.

Finally, it is determined whether or not the third test mode is satisfied; that is, whether or not the semiconductor memory device is suboptimal (step 170) at the first frequency region.

If the third test mode is not satisfied, it is indicated that the first frequency region is suboptimal, and the test is finished (step 180). That is, since the third frequency region and the second frequency region have satisfied the test at the steps 100 and 110, and the steps 130 and 140, if the test is not satisfied at the step 170, it can be seen that the first frequency region is suboptimal.

If the third test mode is satisfied, it is determined that the semiconductor memory device is normal, and the test is finished.

In the above embodiments, the semiconductor memory device has been described to have three frequency regions as an example, and the invention can be applied to the semiconductor memory device having two or more frequency regions.

Therefore, in case that the semiconductor memory device has a plurality of frequency regions, the semiconductor memory device has an independent data path which connects input and output circuits of respective frequency regions and performs a test for respective frequency regions, and thus it can be seen which frequency regions among a plurality of frequency regions may be suboptimal.

As described herein before, the semiconductor memory device and the method of testing the same according to the invention can recognize which frequency regions among a plurality of frequency regions may be suboptimal when the semiconductor memory device has a plurality of frequency regions.

What is claimed is:

1. A semiconductor memory device, comprising:
a memory for receiving or outputting data in response to a first clock signal;
an input converting means for converting and outputting input data in response to a second clock signal; and
an output converting means for converting and outputting data outputted from the memory in a first test mode and converting and outputting data outputted from the input converting means in a second test mode, in response to the second clock signal.

2. The device of claim 1, wherein a frequency of the second clock signal is higher than a frequency of the first clock signal.

3. The device of claim 1, wherein the input converting means is a write pipe that de-serializes and outputs data inputted from an external device.

4. The device of claim 1, wherein the output converting means is a read pipe which serializes and outputs data inputted from the memory or the input converting means.

5. The device of claim 1, further comprising:
a first switching means connected between the input converting means and the output converting means; and
a second switching means connected between the memory and the output converting means.

6. The device of claim 5, wherein the first and second switching means comprise a plurality of transmission gates.

7. The device of claim 5, wherein the first and second switching means comprise a plurality of multiplexers.

8. The device of claim 5, further comprising, a control signal generator for outputting control signals which respectively control the first and second switching means in response to a command applied from an external device.

9. The device of claim 8, wherein the control signal generator comprises a mode setting register.

10. A semiconductor memory device, comprising:
a memory for receiving or outputting data in response to a first clock signal;
a first input converting means for converting and outputting input data in response to a second clock signal; and
a first output converting means for converting and outputting data outputted from the memory in a first test mode and converting and outputting data outputted from the input converting means in a second test mode, in response to the second clock signal;
a second input converting means for converting and outputting input data in response to a third clock signal; and
a second output converting means for converting and outputting data outputted from the first output converting means in the first test mode or the second test mode and converting and outputting data outputted from the second input converting means in a third test mode, in response to the third clock signal.

11. The device of claim 10, wherein a frequency of the third clock signal is higher than a frequency of the second clock signal, and a frequency of the second clock signal is higher than a frequency of the first clock signal.

12. The device of claim 10, wherein the first input converting means is a write pipe that de-serializes and outputs data inputted from the second input converting means.

13. The device of claim 10, wherein the second input converting means is a write circuit that de-serializes and outputs data inputted from an external device.

14. The device of claim 10, wherein the first output converting means is a read pipe which serializes and outputs data inputted from the memory or the first input converting means.

15. The device of claim 10, wherein the second output converting means is a read circuit which serializes and outputs data inputted from the first output converting means or the second input converting means.

16. The device of claim 10, further comprising:
a first switching means connected between the first input converting means and the first output converting means;
a second switching means connected between the second input converting means and the second output converting means;
a third switching means connected between the memory and the first output converting means; and
a fourth switching means connected between the first output converting means and the second output converting means.

17. The device of claim 16, wherein the first, second, third, and fourth switching means comprise a plurality of transmission gates.

18. The device of claim 16, wherein the first, second, third, and fourth switching means comprise a plurality of multiplexers.

19. The device of claim 16, further comprising, a control signal generator for outputting control signals which respectively control the first, second, third, and fourth switching means in response to a command applied from an external portion.

20. The device of claim 19, wherein the control signal generator comprises a mode setting register.

21. A method of testing a semiconductor memory device including a memory for receiving or outputting data in response to a first clock signal, and an input/output means for converting and outputting data in response to a second clock signal, the method comprising:
testing the input/output means; and
testing the memory.

22. The method of claim 21, wherein a frequency of the second clock signal is higher than a frequency of the first clock signal.

23. A method of testing a semiconductor memory device including a memory for receiving or outputting data in response to a first clock signal, a first input/output means for converting and outputting data in response to a second clock signal, and a second input/output means for converting and outputting data in response to a third clock signal, the method comprising:
testing the second input/output means;
testing the first input/output means; and
testing the memory.

24. The method of claim 23, wherein a frequency of the third clock signal is higher than a frequency of the second clock signal, and the frequency of the second clock signal is higher than a frequency of the first clock signal.
